(19) United States
(12) Patent Application Publication
(10) Pub. No.: US 2007/0171375 A1
(43) Pub. Date: Jul. 26, 2007

(54) Display device

(75) Inventors: Kiminori Mizuuchi, Osaka (JP); Kazuhisa Yamamoto, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Osaka (JP)

(21) Appl. No.: 10/590,809

(22) PCT Filed: Feb. 22, 2005
(86) PCT No.: PCT/JP05/02803

§ 371 Date: Aug. 25, 2006

(30) Foreign Application Priority Data
Feb. 27, 2004 (JP) 2004-054092

(51) Int. Cl. G03B 21/26

(52) U.S. Cl. 353/30; 353/79

(57) ABSTRACT

There is provided a laser display device that is applicable to mobile equipment, which device prevents laser light from being applied to a region other than a screen.

A laser display device (100) is provided with a laser projection part (101) comprising at least one coherent light source and an optical system for converting light from the coherent light source into video, a screen (103) onto which the light emitted from the laser projection part (101) is projected, and an arm (102) that is attached to the screen (103) and supports the laser projection part (101), and the movable range and movable direction of the laser projection part (101) are limited by the arm (102) so that light from the laser projection part (101) is applied to only the screen (103).

### TECHNICAL FIELD

The present invention relates to a portable display device employing laser light irradiation.

### BACKGROUND ART

A display using a visible range laser light source can be reduced in size and power consumption, and it realizes full-color image display by using three primary color lasers of R, G, and B. Further, a laser can represent a wide range of chromaticity. Like a laser display device shown in Patent Document 1 (Japanese Published Patent Application No. 2003-279889) or Patent Document 2 (Japanese Published Patent Application No. Hei. 10-293268), bright color image display can be realized by using lasers as light sources.

Conventionally, laser displays have been developed mainly for outdoor displays having solid lasers as light sources, and relatively large display devices used in theaters and the like. On the other hand, compact laser displays can realize low power consumption by using semiconductor lasers as light sources, and are suitable for mobile applications.

However, in order to use a laser display for mobile application, there occurs a security risk. Since, generally, a laser light source has high coherency and high directivity, a high power density is obtained when laser light is condensed, and therefore, the laser light source is desirably used under the state where safety standard is secured. Depending on the light source output, when there is a possibility that the condensed laser light of high power density might directly irradiate people around the laser source, utilization of the laser light source is strictly regulated.

### DISCLOSURE OF THE INVENTION

### Problems to be Solved by the Invention

As described above, when a laser display is used for mobile application, the emitted laser light might irradiate people around the laser source. Therefore, in mobile application, security must be sufficiently ensured considering those around the laser source.

For example, when a user views an image on the display device, illuminance of the image is an important element, and intensity of 10 mW˜100 mW is required of the light source. In this case, the laser light with the coherency being high must be prevented from directly irradiating people around the display device. That is, in the laser display, it is necessary to design the display device so that the high coherency laser light does not directly irradiate human body.

The present invention is made to solve the above-mentioned problems and has for its object to provide a display device which can prevent laser light from directly irradiating objects other than a screen, and which is compact to be applicable to mobile use.

### MEASURES TO SOLVE THE PROBLEMS

In order to solve the above-mentioned problems, a display device according the invention of claim 1 comprises at least one coherent light source having a visible-range wavelength, a laser projection part having a video conversion optical system for converting light from the coherent light source into video, a screen onto which the light emitted from the laser projection part is projected, and a support member for supporting the laser projection part, which is attached to the screen, and a region to be directly irradiated with the light emitted from the laser projection part is limited to a region on the screen.

Therefore, the laser light is prevented from directly being applied to a part other than the screen, whereby the laser display can be driven safely.

According to the invention of claim 2, in the display device as defined in claim 1, the laser projection part has a movable range and a movable direction which are limited by the support member so that the light from the laser projection part is incident on only the screen.

Therefore, the laser light is prevented from directly being applied to a part other than the screen.

According to the invention of claim 3, in the display device as defined in claim 1, the laser projection part varies the intensity of laser irradiation according to a difference in intensities of laser lights between a region on the screen which is irradiated with the laser light and a region which is not irradiated with the laser light.

Therefore, it is possible to obtain an optimum image according to an environment where the display device is used.

According to the invention of claim 4, in the display device as defined in claim 1, the video conversion optical system includes a two-dimensional switch array for spatially modulating the light emitted from the coherent light source, and a lens optical device for expanding and projecting an image of the two-dimensional switch array.

Therefore, it is possible to obtain a high-definition and high-tone image, using semiconductor lasers as light sources.

According to the invention of claim 5, in the display device as defined in claim 1, the video conversion optical system has a beam scanner for scanning the light emitted from the coherent light source so that a two-dimensional image is formed on the screen.

Therefore, the optical system can be reduced in size, resulting in a downsized display device.

According to the invention of claim 6, in the display device as defined in claim 1, the coherent light source includes at least three light sources, and the respective light sources have wavelengths of 430˜455 nm, 630˜650 nm, and 510˜550 nm, respectively.

Therefore, reproducibility of expression colors can be enhanced, and reduction in power consumption can be achieved.

According to the invention of claim 7, in the display device as defined in claim 1, the screen is of a foldable structure that can extend its surface area up to two times or more.

Therefore, portability of the display device can be enhanced.

According to the invention of claim 8, in the display device as defined in claim 7, the arm is of a structure that can extend its length, and a light projection area on the screen onto which the light from the optical system is projected varies in association with the length of the arm and the area of the screen.

Therefore, even when the surface area of the screen is changed, the laser light is prevented from directly being applied to a part other than the screen, whereby safety of the display device can be enhanced.

According to the invention of claim 9, in the display device as defined in claim 1, the screen is constituted by a diffusion plate, and a diffraction angle of the light reflected by the screen or a diffraction angle of the light transmitted through the screen is restricted so that the reflected light or the transmitted light has directionality.

Therefore, the view angle of the display device can be set according to the purpose of use. Further, by limiting the view angle, the laser power can be suppressed, resulting in reduced power consumption.

According to the invention of claim 10, the display device as defined in claim 1 further includes a photodetector for detecting a portion of the reflected light from the screen, and projection of light from the laser projection part is controlled on the basis of the state of the reflected light that is detected by the photodetector.

Therefore, feedback control of image can be carried out, whereby high-definition image can be obtained. Further, the irradiation state of the laser light can be detected and the laser irradiation can be stopped if needed, whereby safety of the display device is enhanced.

According to the invention of claim 11, in the display device as defined in claim 1, the coherent light source is mounted on the screen, and the light from the coherent light source is supplied to the video conversion optical system through a light transmitting medium.

Therefore, the optical system can be miniaturized, whereby miniaturization of the display device is realized.

According to the invention of claim 12, in the display device as defined in claim 11, the light transmitting medium is an optical fiber.

Therefore, the coherent light source can be disposed in a place other than the laser projection part, whereby miniaturization of the optical system is achieved.

### EFFECTS OF THE INVENTION

According to the present invention, the laser projection part that emits laser light and the screen are connected through the arm, and the adjustment ranges of the angle and position of the laser projection part are limited by the arm. Therefore, the laser light emitted from the laser projection part is prevented from being directly applied to a part other than the screen, whereby the laser display can be driven safely.

Further, since both the screen and the arm are foldable, portability of the disk device is enhanced.

### BRIEF DESCRIPTION OF THE DRAWING

FIG. 1 is a diagram showing the schematic structure of a laser display device according to a first embodiment of the present invention, illustrating the state where an arm of the laser display device is folded (FIG. 1(a)), and the state where the arm is turned up when the laser display device is used (FIG. 1(b)).

FIG. 2(a) is a diagram illustrating the structure of a laser projection part in the laser display device of the first embodiment, and FIG. 2(b) is a diagram illustrating the specific structure of a laser light source.

FIG. 3 is a diagram for explaining a laser display device according to a second embodiment of the present invention, illustrating a scanning type optical system that constitutes a laser projection part.

FIG. 4 is a diagram for explaining a laser display device according to a third embodiment of the present invention, illustrating the state where an arm of a rear-projection type laser display device is folded (FIG. 4(a)), and the state where the arm is stood up when the device is used (FIG. 4(b)).

FIG. 5 is a diagram for explaining a laser display device according to a fourth embodiment of the present invention, illustrating the state where a light source of a rear-projection type laser display device is turned down (FIG. 5(a)), and the state where the light source is stood up when the device is used.

FIG. 6 is a diagram for explaining a laser display device according to a fifth embodiment of the present invention, illustrating the state where a screen is folded (FIG. 6(a)), the state where the screen is expanded (FIG. 6(b)), and the state where an arm is stood up when the device is used (FIG. 6(c)).

FIG. 7 is a diagram for explaining the procedure of expanding a foldable screen of the laser display device according to the fifth embodiment, illustrating the state where the screen is folded (FIG. 7(a)), the state where the screen is being expanded (FIG. 7(b)), and the state where the screen is expanded (FIG. 7(b)).

FIG. 8 is a diagram for explaining a laser display device according to a sixth embodiment of the present invention, illustrating the state where a screen is folded (FIG. 8(a)), and the state where the screen is expanded (FIG. 8(b)).

### DESCRIPTION OF THE REFERENCE NUMERALS

101,401,501,601 . . . laser projection part
102,502,602,801 . . . arm
103,603 . . . screen
201 . . . light source
202 . . . two-dimensional switch
203 . . . prism
204 . . . lens
205a˜205c . . . R, G, B light sources
206 . . . diffraction element
301a˜301c . . . light sources
302,303 . . . mirror
502 . . . support pedestal
602a˜602c . . . first to third tube-shaped arm members
603a˜603d . . . screen pieces
701a˜701c . . . shaft members
801a . . . projection
802b . . . fitting concave part
803,804 . . . support pin

### BEST MODE TO EXECUTE THE INVENTION

Hereinafter, embodiments of the present invention will be described with reference to the drawings.

### Embodiment 1

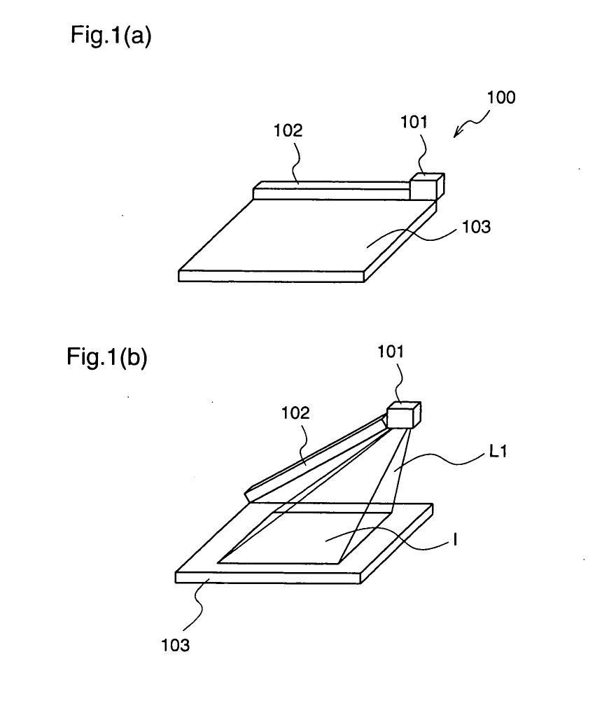

FIG. 1 is a diagram illustrating a schematic structure of a laser display device 100 according to a first embodiment of the present invention.

The laser display device 100 includes a laser projection part 101, an arm 102, and a screen 103, and the laser projection part 101 is supported by the arm 102 that is attached to the screen 103.

The laser projection part 101 includes at least one laser light source that emits laser light, and an image conversion optical system for converting the laser light emitted from the laser light source into an image I.

An end of the arm 102 is rotatably attached to the screen 103, and the laser projection part 101 is rotatably attached to the other end of the art 102. A turning angle of the arm 102 with respect to the screen 103, and a rotation angle in the horizontal direction of the arm 102 with respect to the screen 102 are limited in predetermined ranges, respectively. Further, the movable range and movable direction of the laser projection part 101 with respect to the arm 102 are also limited so that emitted light L1 from the laser projection part 101 does not run off the edge of the screen 103.

This laser display device 100 is usually put in the state where, as shown in FIG. 1(a), the laser projection part 101 and the arm 102 are folded with respect to the screen 103. When it is used as a display, as shown in FIG. 1(b), the arm 102 is turned up to a predetermined height with respect to the screen 103 to separate the laser projection part 101 by a predetermined distance from the screen 103.

As described above, since the laser projection part 101 and the screen 103 are separated from each other when the laser display device 100 is used, the image conversion optical system in the laser projection part 101 can be simplified. To be specific, when the laser projection part 101 and the screen 103 are close to each other, the scale of enlargement of an image that is enlarged on the screen 103 is increased, whereby the image conversion optical system is complicated, leading to difficulty in miniaturizing the system. Further, the image might be distorted due to aberration of the image conversion optical system, and therefore, high precision is required of the image conversion optical system. On the other hand, when the laser projection part 101 is separated from the screen 103 by the arm 102, the structure of the laser projection part 101 is simplified.

Further, when the laser projection part 101 is supported by the arm 102 so as to be positioned above the screen 103, the range of movement as well as the position during laser projection of the laser projection part 101 with respect to the screen can be limited, thereby preventing the laser light L1 from being directly applied to a part other than the screen 103. Furthermore, when the position of the arm 102 during laser projection is associated with the laser driving, laser irradiation due to malfunction is avoided. For example, a sensor for detecting the rotation angle of the arm 102 is be attached to the arm 102 to detect the position of the arm 102 with respect to the screen 103, and the power supply of the laser display device 100 is prevented from turning on until the position of the arm 102 with respect to the screen 103 enters a safe zone for laser irradiation, thereby preventing error irradiation of the laser light L1 to improve the safety of the laser display device 100.

Further, the space between the screen 103 and the laser projection part 101 when the arm 102 is turned up should be set so as to prevent a head of a person from getting into the space by mistake, and specifically, the space is desired to be narrower than 15 cm.

Next, the laser projection part 101 will be described in detail.

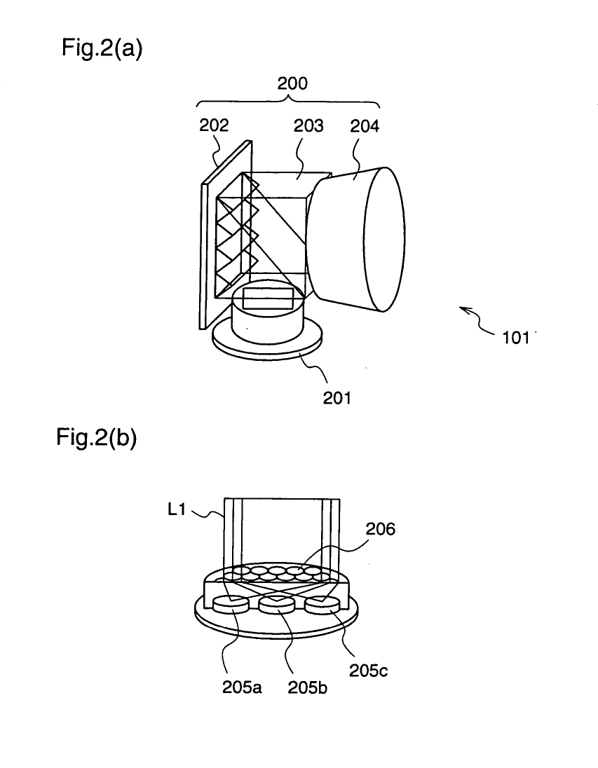

FIG. 2(a) is a diagram illustrating the construction of the laser projection part 101.

As shown in FIG. 2(a), the laser projection part 101 includes a laser light source 201, a two-dimensional switch 202, a prism 203, and a lens 204. Among these elements, the two-dimensional switch 202, the prism 203, and the lens 204 constitute an image conversion optical system 200 for converting laser light emitted from the laser light source 201 into an image I. In the laser projection part 101, the laser light emitted from the laser light source 201 is converted into an image by the image conversion optical system 200 and projected onto the screen 103.

Although there are several methods for converting laser light into an image, a method utilizing the two-dimensional switch 202 shown in FIG. 2(a) will be described. The laser light emitted from the laser light source 201 is projected onto the two-dimensional switch 202 through the prism 203, and an image of the two-dimensional switch 202 is expanded and projected onto the screen 103 by the lens 204, whereby an image is displayed.

There are a method using a liquid crystal switch and a method using a two-dimensional mirror switch constituted by a micro machine, as the two-dimensional switch 202. There are two types of liquid crystal switches, a transparent type and a reflection type, and either type may be used. When using a micro machine, high resolution and high light use efficiency are realized. When using the two-dimensional switch 202, since the laser light is expanded by the image conversion optical system 200 and thereby the power density of the laser light is significantly reduced, the safety of the laser display device 100 is further enhanced.

FIG. 2(b) is a diagram illustrating the specific structure of the laser light source 201. The laser light source 201 including light sources 205a˜205c that are three primary color lasers corresponding to R, G, and B, and a diffraction element 206.

As shown in FIG. 2(b), the surface-emitting lasers 205a˜205c of R, G, B colors are disposed in the package f the laser light source 201, and lights from the respective lasers 205a˜205c are collimated by the diffraction element 206 to be laser light L2.

As for the lasers 205a˜205c, a semiconductor lasers or a combination of a wavelength conversion element and a semiconductor laser may be adopted. For example, red laser light and blue laser light can be realized by an AlGaAsP semiconductor laser and a GaN semiconductor laser, respectively. Further, green laser light can be realized by wavelength-converting a semiconductor laser with a wavelength conversion element. At this time, temporal coherence of light can be reduced by superposing an RF wave on the semiconductor laser. That is, when an RF wave is superposed on the semiconductor laser, the oscillation wavelength spectrum of the semiconductor laser is expanded, and the coherence is reduced. Thereby, the focusing property of the light source is degraded, resulting in safer light. Further, since the speckle noise caused by interference of the laser light L1 can be reduced, higher definition image display can be carried out.

Hereinafter, a description will be given of the oscillation wavelengths of the R, G, B light sources in the laser display device 100 according to the first embodiment. In the laser display device 100, the wavelength and the visibility are in close relation with each other, and the wavelength to be used and the light intensity to be required are determined considering the influence on the visibility, and further, the wavelength and the range of color reproducibility are determined considering the influence on the chromaticity. Therefore, the oscillation wavelengths of the R, G, B light sources are important in the laser display device 100.

For example, when the wavelength of the red light is fixed to 640 nm while the wavelength of the green light is fixed to 532 nm, the visibility of the blue light is reduced when the wavelength thereof becomes lower than 430 nm, and therefore, the power required for expressing the blue dramatically increases. Further, since the blue light approaches the area of the green when the wavelength thereof exceeds 460 nm, large power for expressing the blue is required and the expressible color range is narrowed, and moreover, the power of the red must be increased to increase the color range. On the other hand, as for a blue laser comprising GaN semiconductor, a high output laser is realized usually at a wavelength near 410 nm. Although the dose of In must be increased to shift this wavelength to the longer-wavelength side, such increase in dose of In causes segregation of In and thereby degrades crystal composition, leading to reductions in reliability and high output characteristic of the semiconductor laser. Accordingly, it is desired to set the wavelength of the blue laser adopting GaN to 455 nm or less. From the viewpoint of color reproducibility, it is preferable to use a blue light source of a relatively short wavelength because the range of colors expressible in the blue region is extended.

From the above-mentioned viewpoints, the wavelength region of the blue laser is preferably 430 nm˜455 nm. More preferably, it is desired to be 440 nm˜450 nm. By using the blue light in this wavelength range, reduced power consumption and high color reproducibility are achieved by the reduction in the required power.

A red semiconductor laser is implemented by an AlGaAs system semiconductor material or an AlGaInP system semiconductor material. In order to realize high power output, the wavelength region of the red semiconductor laser is desired to be 630 nm˜650 nm, and more preferably, it should be 640 nm+5 nm in order to improve the visibility and expand the usage wavelength range of the blue light.

A green laser is realized by a ZnSe system semiconductor laser. As for the ZnSe system semiconductor laser, since the light power density in the waveguide is high in a Fabry-Perot semiconductor laser, it is difficult to obtain reliability. However, when the surface-emitting laser of the construction according to the present invention is employed, reduction in the light power density in the crystal can be achieved, thereby assuring high reliability. Although a wavelength region of 510 nm˜550 nm is required when color balance is considered, the wavelength region is desired to be 510 nm˜520 nm when reliability of the surface emitting laser is considered, and in this case, high reliability and high output characteristic can be realized. Further, a green surface emitting laser can also be realized by doping a great amount of In into GaN. Also in this case, the wavelength region is desired to be 500 nm˜520 nm.

In order to further expand the chromaticity range, a fourth light may be added to the three primary colors, whereby the color reproducibility is significantly improved. A color to be added may be blue-green with a wavelength near 480 nm. This region is a color region which cannot be realized by the chromaticity range comprising the three primary colors, and therefore, the expressible color region is significantly extended.

The place where the light sources 205a˜205c having the above-mentioned characteristics are to be disposed is not restricted to the inside of the laser projection part 101, and these light sources may be disposed on the arm 102 or the screen 103. In this case, supply of laser light from outside of the laser projection part 101 is realized by connecting the light sources 205a˜205c with the laser projection part 101 using an optical system such as an optical fiber. As described above, when the light sources 205a˜205c are provided in a place outside the laser projection part 101, the laser projection part 101 can be miniaturized, and the portability of the laser display device 100 can be improved.

Next, the screen 103 will be described in detail.

The screen 103 has a fine concavo-convex pattern that diffuses the laser light L1 emitted from the laser projection part 101. Using the screen of this structure has two meanings.

One is control of the view angle of the display. The user of the laser display device 100 recognizes the image on the screen 103 by the reflected beam of the laser light L1 from the laser projection part 101. Therefore, the range within which the reflected light is diffused is the view angle. With an increase in the diffusion angle of the screen 103, the view angle is increased but the brightness of the display is degraded. Therefore, when the diffraction angle is limited by forming the fine concavo-convex pattern on the screen 103, the laser power can be suppressed, thereby achieving reduction in power consumption. Further, by changing the diffusion angle, it is possible to change the device from one for personal use having a narrow view angel to one for plural persons having a wide view angle.

Further, when utilizing the diffraction element, it is possible to make the reflection or transmission of the laser light L1 have directionality. There are plural patterns of positional relationships between the irradiation direction of the laser light L1 and the person who views the screen 103, depending on the construction of the laser display device 100 such as the position where the arm 102 and the screen 103 are connected. In order to view the image that appears on the screen 103 brightly and vividly, it is necessary to efficiently condense the reflected beam of the laser light L1 toward the viewer. In order to realize this function, the diffraction element is important. Since the laser light source is a high coherence light source, the wavelength spectrum of the laser light L2 is very narrow. Therefore, design of the diffraction element is significantly facilitated. Further, when the diffraction element is constituted so that the diffraction direction and the diffraction angle are variable by using liquid crystal or the like, the diffraction direction and the diffraction angle of the laser light L1 can be arbitrarily controlled. For example, in a well-lighted place or a place where light enters through window, the diffraction direction of the laser light L1 is made to have directionality different from the direction of the peripheral light, whereby brighter image can be obtained.

The other reason of forming the fine concavo-convex pattern on the screen 103 is to ensure the safety. Since the laser light L1 has high coherence, when the reflected light from the screen 103 is condensed by some kind of lens function, the light might have high power density. In order to solve this problem, it is effective to reduce the coherence of the laser light L1. When the coherence is reduced, the light condensing characteristic is degraded, and the laser light L1 can be used under the same environment as that for the ordinary lamp light. In order to realize this, the fine concavo-convex pattern is formed on the screen 103 to use the screen 103 as a diffusion plate. Since the spatial coherence of the laser light L1 that is reflected at or transmitted through the diffusion plate is significantly reduced, the focusing characteristic is significantly reduced. Thereby, the laser light L1 is prevented from being condensed to a high power density, thereby increasing the safety.

As described above, the display device according to the first embodiment is provided with the laser projection part 101, the screen 103, and the arm 102, and the position of the laser projection part 101 with respect to the screen 103 and the light emission direction from the laser projection part 101 is limited by the arm 102. Therefore, the laser light L1 emitted from the laser projection part 101 is prevented from directly being applied to a part other than the screen 103, whereby the safety of the laser display device can be ensured.

Further, since semiconductor lasers are used as light sources, miniaturization of the laser display device can be achieved. Further, since the semiconductor lasers are driven within predetermined wavelength ranges, reduction in power consumption is achieved.

### Embodiment 2

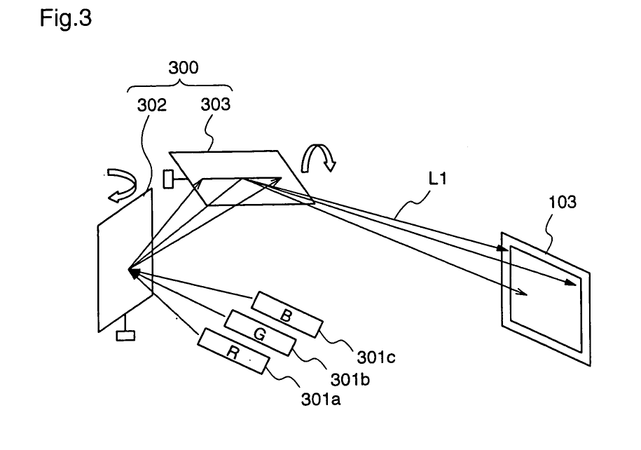

FIG. 3 is a diagram for explaining a laser display device according to a second embodiment of the present invention, illustrating the construction of a laser irradiation part in the laser display device.

The laser display device according to the second embodiment is provided with a scanning type optical system 300 instead of the image conversion optical system 200 using the two-dimensional switch in the laser projection part 101 of the first embodiment.

With reference to FIG. 3, 301a˜301c denote light sources of three primary colors R, G, and B, and 302 and 303 denote mirrors for scanning laser lights emitted from the R, G, B three primary color light sources 301a˜301c.

The scanning type optical system 300 scans the laser lights that are emitted from the R, G, B primary color light sources 301a˜301c and collimated, with the mirror 302 in the horizontal direction, and further, scans the lights with the mirror 303 in the vertical direction, thereby to display a two-dimensional image on the screen. The scanning mirrors 302 and 303 have very small loss of light, and utilize the lights with high efficiency.

In the laser display device using the scanning type optical system 300, since the light beams are collimated and have high power densities, it is necessary to particularly consider the safety.

In order to enhance the safety, it is desirable that the screen 103 is provided with a diffusion function to greatly reduce the coherence of the light reflected at the screen 103. Further, it is desired to provide a safeguard that automatically stops irradiation of the laser light when scanning of the laser light in the scanning type optical system 300 is stopped. In the scanning type optical system 300, as a method of laser light scanning, a method using a polygon mirror or a method utilizing a micromachine is applicable. Especially when a micromachine is used, a ultracompact laser projection part can be realized.

Further, when a plurality of laser projection parts 101 are provided, interference of the laser light L1 on the screen 103 can be avoided, whereby the speckle noise can be further reduced.

As described above, according to the second embodiment, the laser display device is provided with the beam scanner that scans the light from the coherent light source so as to form a two-dimensional image on the screen, instead of the image conversion optical system using the two-dimensional switch according to the first embodiment. Therefore, the optical system can be miniaturized, leading to a compact display device.

### Embodiment 3

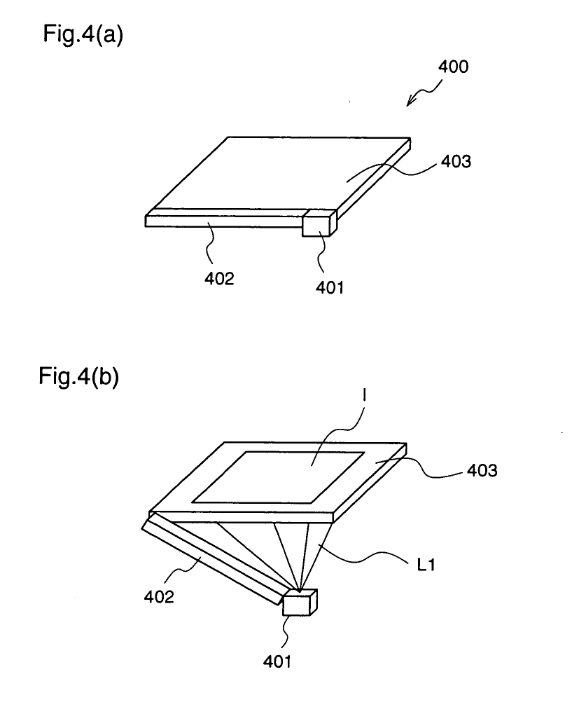

FIG. 4 is a diagram for explaining a laser display device according to a third embodiment of the present invention, wherein FIG. 4(a) shows the state where an arm of a laser display device 400 is folded, and FIG. 4(b) shows the state where the arm is turned up when using the laser display device 400.

The laser display device 400 according to the fourth embodiment is a rear-projection laser display device.

The laser display device 400 is provided with a laser projection part 401, an arm 402, and a transparent screen 403. The laser projection part 401 is supported by the arm 402 so as to be positioned on the back side of the screen 403.

The laser projection part 401 includes, like the laser projection part 101 of the first embodiment, at least one laser light source emitting laser light, and an image conversion optical system for converting the laser light emitted from the laser light source into an image I.

An end of the arm 402 is rotatably attached to the screen 403, and the laser projection part 401 is rotatably attached to the other end of the arm 402. The turning angle of the arm 402 with respect to the screen 403 and the rotation angle of the arm 402 in the horizontal direction with respect to the screen 402 are respectively limited within predetermined ranges, and further, the movable range and movable direction of the laser projection part 401 with respect to the arm 402 are also limited within predetermined ranges. Since the movable ranges of the arm 402 and the laser projection part 401 are limited within the predetermined ranges, the irradiation region of the emitted light L1 from the laser projection part 401 can be limited to the region on the screen 403.

The laser display device 400 according to the third embodiment is greatly different from the reflection type laser display device 100 according to the first embodiment shown in FIG. 1 in that the arm 402 is turned toward the rear surface side of the screen 403, and the laser light L1 is projected from the rear surface of the screen 403.

The laser light L1 emitted from the laser projection part 401 is applied to the screen 403, and the laser light L1 that transmits through the screen 403 is displayed as an image I on the screen 403. Since the fine concavo-convex pattern is formed on the screen 403, the laser light L1 is diffused on the screen 403.

The rear-projection laser display device 400 according to the third embodiment realizes further increase in safety as compared with the reflection type device of the first embodiment. For example, in the laser display device 400, when the rear surface of the screen 403 is covered, the laser light applied to the screen 403 can be completely shut out from the outside. In this case, there is no possibility that the laser light L1 is directly applied to the outside, and therefore, the safety is reliably ensured. Further, since the laser light L1 applied to the screen 403 is diffused, the spatial coherency thereof is reduced, whereby the laser light L1 can be used with the same safety standard as that for an ordinary lamp or the like.

### Embodiment 4

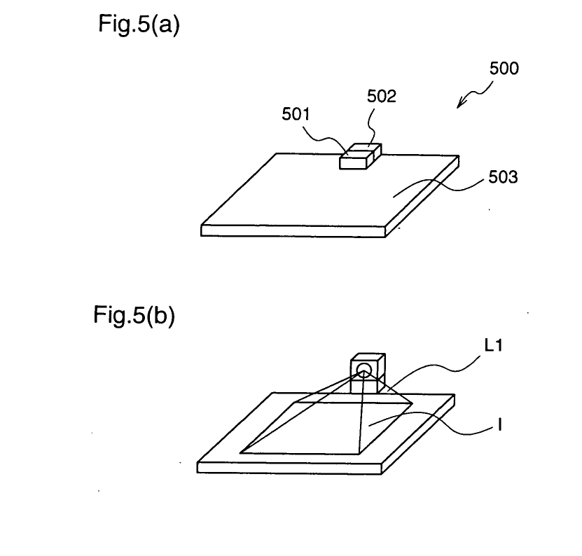

FIG. 5 is a diagram for explaining a laser display device according to a fourth embodiment of the present invention, wherein FIG. 5(a) shows the state where a support pedestal of a laser projection part of a laser display device 500 is turned down, and FIG. 5(b) shows the state where the support pedestal of the laser projection part is turned up when using the laser display device 500.

The laser display device 500 is provided with a laser projection part 501, a support pedestal 502, and a screen 503. The laser projection part 501 is supported by the support pedestal 502 which is rotatably attached to the screen 503 so that it is positioned at the front surface side of the screen 503.

The laser projection part 501 is fixed to the support pedestal 502, and the support pedestal 502 is fixed by using a hinge or the like so that it stands vertically with respect to the screen 503. The screen 503 has a periodical concavo-convex structure to obtain a function as a diffusion plate and a diffraction effect.

In the laser display device 100 according to the first embodiment shown in FIG. 1, the laser irradiation part 101 is supported by the long arm 102, and irradiation of the laser light L1 is performed from above the screen 103. In contrast to the first embodiment, in the laser display device 500, the laser irradiation part 501 is supported by the low support pedestal 502 that is attached to the screen 503 so that it can stand vertically, and irradiation of laser light is performed from a position near the side surface of the screen 503, with the support pedestal 502 of the laser projection part 501 being stood.

In the laser display device 500 according to the fourth embodiment, the laser light L1 emitted from the laser projection part 501 is diffused and diffracted by the screen 503, and reflected in the direction vertical to the screen 503. Thereby, the image-converted light can be applied to a person who views the screen 503 from the front surface.

According to the fourth embodiment of the present invention, it is possible to realize a very compact laser display device.

While in this fourth embodiment a reflection type laser display device is described, it is possible to constitute an arm standing type rear-projection laser display device by using a transparent screen.

Further, it is desirable to use, as the image optical system of the laser projection part 501, the scanning type system as shown in FIG. 3. The reason is as follows. In the optical system using a lens as shown in FIG. 2, there may occur image distortion according to the distance from the laser projection part 501 to the screen 103, and a special mechanism for correcting such distortion is needed.

Further, the laser display devices 100, 400, and 500 according to the respective embodiments mentioned above may use photodetectors (not shown) as the laser projection parts. The function of the laser display can be significantly enhanced when the photodetector is provided. For example, the image I on the screen 103 can be monitored with the photodetector, and thereby more beautiful image can be reproduced by feeding back such as the color and the contrast of the image I.

To be specific, the intensity or the ratio of the emitted laser light L1 can be controlled by detecting such as the brightness and the color tone of the image, whereby optimum color tone can be reproduced in any case. Further, when a material including image information which is disposed on the screen 103, such as a script on which letters are printed, is irradiated with the laser light 1, and the reflected light is detected by the photodetector, whereby the display device can also be utilized as a copy machine that reads the image information. Especially when three primary color lasers are used as laser light sources, a simple color copy machine can be realized.

Furthermore, the photodetector is effective from the viewpoint of safety. For example, when a foreign material exists between the laser projection part 101 and the screen 103 or when scanning of the laser light in the laser projection part 101 is stopped for some reason, the abnormality can be detected by the photodetector to stop the laser irradiation. Further, it is possible to detect that the irradiation spot of the laser light L1 deviates from the screen 103 by detecting the reflected beam of the laser light L1 with the photodetector, and therefore, the safety can be further enhanced by stopping irradiation of the laser light L1 when the laser light L1 irradiates a region other than the screen 103. As described above, by detecting error irradiation of the laser light L1 using the photodetector, the limitations required to secure the safety, such as the shape and hardness of the arm 102 or the position where the laser projection part 101 is fixed, can be eased, whereby the degree of freedom in designing the laser display device can be significantly increased.

### Embodiment 5

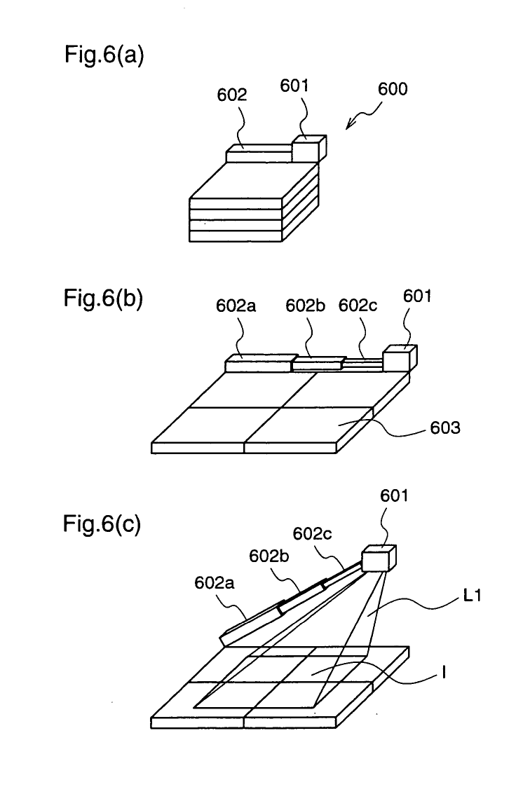

FIG. 6 is a diagram for explaining a laser display device according to a fifth embodiment of the present invention.

A laser display device 600 according to the fifth embodiment is obtained by modifying the laser display device 100 according to the first embodiment so as to make the arm storable and the screen foldable in the laser display device 100 according to the first embodiment, thereby to assure the safety and enhance the portability.

FIG. 6(a) shows the state where the laser display device 600 is folded, FIG. 6(b) shows the state where the screen is expanded, and FIG. 6(c) shows the state where the laser display device 600 is used with the arm 602 being turned up.

As shown in FIG. 6(a), the laser display device 600 includes a laser projection part 601, an arm 602, and a screen 603. The laser projection part 601 is supported by the art 602 attached to the screen 603. The laser projection part 601 is identical to that described for the first embodiment.

The screen 603 is collapsible, and it can be expanded as shown in FIG. 6(a) or 6(c) from the state where it is stored as shown in FIG. 6(a). Hereinafter, the construction of the screen 603 will be described.

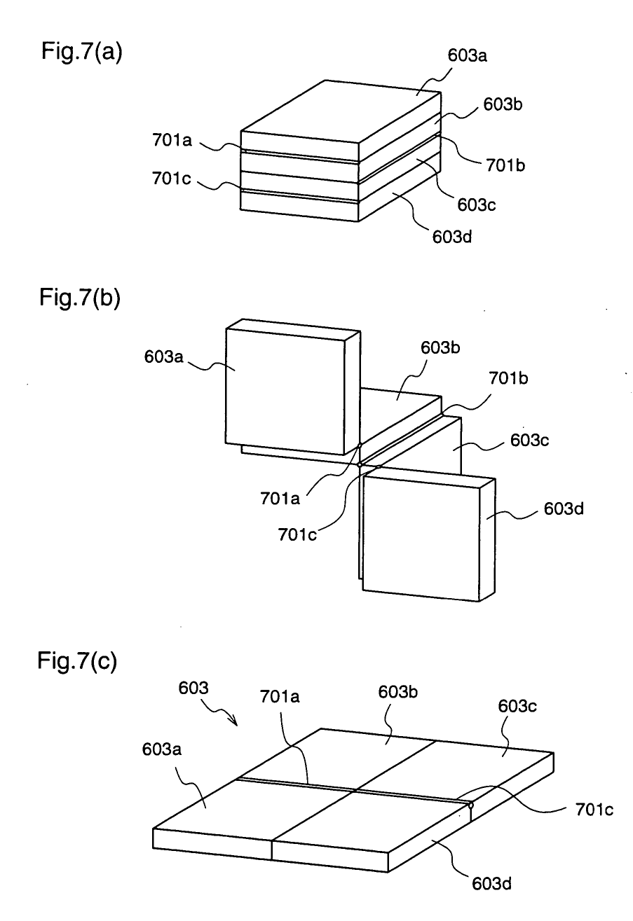

FIG. 7 is a diagram for explaining the structure of the screen 603. FIG. 7(a) shows the state where the screen 603 is stored, FIG. 7(b) shows the state where the screen 603 is being expanded, and FIG. 7(c) shows the state where the screen is expanded.

The screen 603 is, as shown in FIG. 7, composed of four screen pieces 603a˜603d, and the screen piece 603a and the screen piece 603b are connected by a shaft 701a, the screen piece 603b and the screen piece 603c are connected by a shaft 701b, and the screen piece 603c and the screen piece 603d are connected by a shaft 701c, thereby forming one screen 603 comprising these four screen pieces.

Since the screen 603 is constituted as described above, the screen 603 can take the folded shape as shown in FIG. 7(a), and the extended shape as shown in FIG. 7(c).

The mechanism of extending the screen 603 is not restricted to that described above. For example, a plurality of thin screen pieces may be connected so as to be accordion foldable. Alternatively, individual screen pieces may be provided with, on their side surfaces, joint projections and joint grooves, and the screen pieces are connected using the joint projections and joint grooves to produce one screen. As a material of the screen 603, a hard material or a shape-memory material can be used.

As shown in FIG. 6(b), the arm 602 comprises a first tube-shaped arm member 602a, a second tube-shaped arm member 602b, and a third tube-shaped arm member 602c. The second tube-shaped arm member 602b is slidably inserted into the first tube-shaped arm member 602a, and similarly, the third tube-shaped arm member 602c is slidably inserted into the second tube-shaped arm member 602b. The first tube-shaped arm member 602a, the second tube-shaped arm member 602b, and the third tube-shaped arm member 602c are provided with engagement parts (not shown), and the second tube-shaped arm member 602b and the third tube-shaped arm member 602c are regulated so as not to extend over a predetermined length by engaging the respective engagement parts. In this way, since the respective tube-shaped arm members are prevented from extending over the predetermined lengths, the laser light L1 is prevented from directly being applied to a region other than the screen 603.

Next, the function and effect will be described.

When the laser display device 600 is used in the stored state shown in FIG. 6(a), the arm 602 is turned up to a predetermined height without extending it, and the laser projection part 601 is fixed to a predetermined position, and then the laser light L1 is emitted.

Sensors for detecting expansion of the screen 603 and the extension of the arm 602 are provided, and the laser projection part 601 is controlled to stop irradiation of the laser light L1 if the arm 602 is extended with the screen 603 being not expanded, whereby the laser light L1 is prevented from being applied to a part other than the screen 603.

Further, when the laser display device 600 is expanded to be used, the screen 603 is expanded as shown in FIG. 6(b) from the state shown in FIG. 6(a), and then the arm 602 is extended. Further, as shown in FIG. 6(c), the arm 602 is stood up to a predetermined height with respect to the screen 603, and the laser projection part 601 is fixed at a predetermined position.

The laser display device 600 may automatically change the area to which the laser light L1 is projected, according to the extension of the arm 602. When the projection area of the laser light L1 is automatically adjusted according to the size of the screen 603 or the length of the arm 602, the laser light L1 is prevented from directly being applied to a region other than the screen 603.

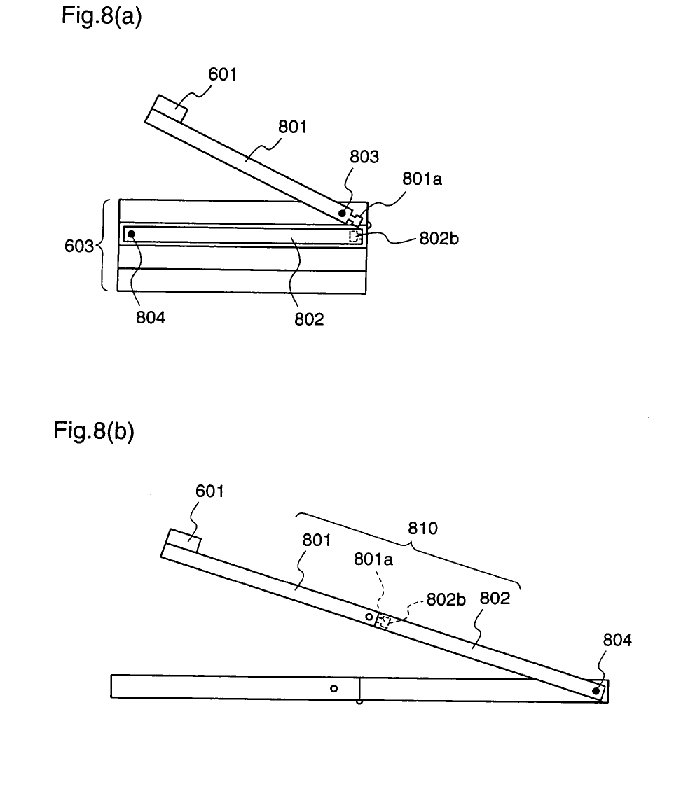

Further, the arm 602 is not restricted to that shown in FIG. 6. As shown in FIG. 8, a fitting type arm may be employed, in which an end of one arm member is fitted to an end of another arm member to change the length of the arm. Hereinafter, the fitting type arm will be described.

FIGS. 8(a) and 8(b) are diagrams for explaining the fitting type arm. FIG. 8(a) is a side view showing the state where the screen 603 is folded, and FIG. 8(b) is a side view showing the state where the screen 603 is expanded.

A first arm member 801 and a second arm member 802 constitute a single long arm 810, and the first arm member 801 and the second arm member 802 are rotatably attached to the screen 603 by support pins 803 and 804, respectively. As shown in FIG. 8(a), a projection 801a is provided at an end of the first arm member 801, and a concave part 802b that fits the projection 801a is provided at an end of the second arm member 802.

When the laser display device 800 is used with the screen 603 being folded, as shown in FIG. 8(a), the first arm member 801 is turned up with the support pin 803 as a supporting point, and the laser light L1 is emitted from the laser projection part 601 onto the surface of the screen (the surface of the screen piece 603a) that is folded as shown in FIG. 6(a).

On the other hand, when laser display device 800 is used with the screen 603 being expanded, as shown in FIG. 8(b), the support pin 803 is removed from the first arm member 801 and the first arm member 801 is separated from the screen 603, and the concave part 802b at an end of the second arm member 802 is fitted to the projection 801a at an end of the first arm member 801. Then, the arm 602 is stood up to a predetermined height with the support pin 803 that supports the second arm member 802 as a supporting point, and the laser light L1 is applied to the expanded screen 603. Since the fitting type arm is used, the arm length when the laser light L1 is emitted is adjusted according to the size of the screen 603, whereby the laser light L1 is prevented from being directly applied to region outside the screen 603.

As described above, in the laser display device 600 of the sixth embodiment, since the arm 602 is constituted to be extendable and the screen 603 is constituted to be foldable, the portability of the laser display device 600 is significantly improved.

Further, since the projection range of the laser light L1 emitted from the laser projection part 601 is limited to the region on the screen 603, the laser light L1 is prevented from directly being applied to a region other than the screen 603, whereby the safety of the portable laser display device 600 can be further enhanced.

While the laser display device 600 according to the sixth embodiment may be a rear-projection type laser display device like the device according to the third embodiment. Further, when the laser display device 600 is provided with a photodetector, the functionality and safety of the laser display device 600 can be improved.

### APPLICABILITY IN INDUSTRY

According to the present invention, in a laser display device that irradiates laser light on a screen to display an image, the laser light is prevented from directly irradiating a region outside the screen. The laser display device is superior in safety and applicable to mobile uses by miniaturizing the same, and therefore, it is useful in realizing a next generation portable laser display.

1. A display device comprising:
at least one coherent light source having a visible-range wavelength;
a laser projection part having a video conversion optical system for converting light from the coherent light source into video;
a screen onto which the light emitted from the laser projection part is projected; and
a support member for supporting the laser projection part, which is attached to the screen;
wherein a region to be directly irradiated with the light emitted from the laser projection part is limited to a region on the screen.

2. A display device as defined in claim 1 wherein
the laser projection part has a movable range and a movable direction which are limited by the support member so that the light from the laser projection part is incident on only the screen.

3. A display device as defined in claim 1 wherein
the laser projection part varies the intensity of laser irradiation according to a difference in intensities of laser lights between a region on the screen which is irradiated with the laser light and a region which is not irradiated with the laser light.

4. A display device as defined in claim 1 wherein
said video conversion optical system includes a two-dimensional switch array for spatially modulating the light emitted from the coherent light source, and a lens optical device for expanding and projecting an image of the two-dimensional switch array.

5. A display device as defined in claim 1 wherein
said video conversion optical system has a beam scanner for scanning the light emitted from the coherent light source so that a two-dimensional image is formed on the screen.

6. A display device as defined in claim 1 wherein
said coherent light source includes at least three light sources, and the respective light sources have wavelengths of 430˜455 nm, 630˜650 nm, and 510˜550 nm, respectively.

7. A display device as defined in claim 1 wherein
said screen is of a foldable structure that can extend its surface area up to two times or more.

8. A display device as defined in claim 7 wherein
said arm is of a structure that can extend its length, and
a light projection area on the screen onto which the light from the optical system is projected varies in association with the length of the arm and the area of the screen.

9. A display device as defined in claim 1 wherein
said screen is constituted by a diffusion plate, and a diffraction angle of the light reflected at the screen or a diffraction angle of the light transmitted through the screen is restricted so that the reflected light or the transmitted light has directionality.

10. A display device as defined in claim 1 further including
a photodetector for detecting a portion of the reflected light from the screen,
wherein projection of light from the laser projection part is controlled on the basis of the state of the reflected light that is detected by the photodetector.

11. A display device as defined in claim 1 wherein
said coherent light source is mounted on the screen, and the light from the coherent light source is supplied to the video conversion optical system through a light transmitting medium.

12. A display device as defined in claim 11 wherein
said light transmitting medium is an optical fiber.
